(19) United States
(12) Patent Application Publication
(10) Pub. No.: US 2019/0291661 A1
(43) Pub. Date: Sep. 26, 2019

(54) METHOD OF MANUFACTURING INSULATION FOR AUTOMOBILES AND INSULATION MANUFACTURED BY THE SAME

(71) Applicant: DAESOL AUSYS CO., LTD., Incheon (KR)

(72) Inventors: Ma BYUNG-JONG, Gyeonggi-do (KR); Min Ho KWON, Seoul (KR)

(73) Assignee: DAESOL AUSYS CO., LTD., Incheon (KR)

(21) Appl. No.: 16/114,488

(22) Filed: Aug. 28, 2018

(30) Foreign Application Priority Data
Mar. 26, 2018 (KR) 10-2018-0034343

(51) Int. Cl. B60R 13/08; B29C 44/02; B29C 44/34; B32B 5/02; B32B 5/20; B32B 5/24; B32B 27/12; B32B 27/40; B32B 27/20

(52) U.S. Cl. CPC B60R 13/083; B29C 44/02; B29C 44/3442; B32B 5/022; B32B 5/20; B29K 2075/00; B32B 27/12; B32B 27/40; B32B 27/20; B60R 13/0838; B32B 5/245

(57) ABSTRACT

A method of manufacturing insulation where carbon nanotubes are added to a polyurethane foam sheet widely used as an insulation substrate, where the cell structure of the foamed polyurethane foam is changed. Accordingly, the NVH performance in a middle and high frequency band of 1,000 Hz or more may be improved while minimizing an increase in weight (lighter than resin felt or glass wool). In particular, since at least one air layer is molded between two polyurethane foam sheets, noise passes through the at least one air layer in the middle of the polyurethane foam sheets when passing through the polyurethane foam sheets, where noise reduction performance may be further improved. In addition, since a mesh made of jute, along with the at least one air layer, is additionally provided between the two polyurethane foam sheets, the sound absorption performance of an insulation may be further improved.

### CROSS-REFERENCE TO RELATED APPLICATION

This application claims priority to and the benefit of Korean Patent Application No. 2018-0034343, filed on Mar. 26, 2018, the disclosure of which is incorporated herein by reference in its entirety.

### BACKGROUND OF THE INVENTION

The present disclosure relates to a method of manufacturing an insulation for automobiles and an insulation manufactured by the same, and more particularly, to a method of manufacturing an insulation for automobiles, characterized by adding carbon nanotubes (CNTs) upon manufacture of a polyurethane foam sheet to change the cell structure of the polyurethane foam sheet and, accordingly, improve the sound absorption performance thereof while reducing the weight of the polyurethane foam sheet, and forming an air layer between two polyurethane foam sheets or additionally including a jute mesh along with the air layer to further increase sound absorption performance.

In general, automobiles are divided into an engine compartment 10 and a passenger compartment 20 by a dash panel D as illustrated in FIG. 1. In addition, the dash panel D is equipped with an insulation I, as illustrated in FIGS. 1 and 2, so as to block noise, vibration, etc. from the engine compartment 10 and the outside under the automobile (under a floor). Further, a hood 30 mounted to open the engine compartment 10 for the purpose of maintenance of an engine or the like is also equipped with an insulation 31 as illustrated in FIGS. 1 and 3.

The insulations 31 and I are manufactured with various materials to increase noise, vibration, and harshness (NVH) performance as in the following patent documents. In many cases, a polyurethane substrate having excellent sound absorption performance with respect to weight is used.

Patent Document 1 proposes a dash insulation for automobiles capable of effectively absorbing and properly reducing noise generated in an engine compartment and introduced into an automobile to increase the NVH performance and marketability of an automobile and improving fuel efficiency due to a light weight thereof, the dash insulation including an upper panel having a structure wherein an aluminum foil panel, a polyurethane foam panel, and a non-woven panel are sequentially stacked in three layers; and a lower panel having a structure wherein a non-woven panel, a glass wool panel, and a non-woven panel are sequentially stacked in three layers, wherein the upper panel is bonded to the lower panel.

Patent Document 2 proposes an inner dash insulation for automobiles having improved sound absorption performance, the inner dash insulation including a hollow sound absorption layer with pores. When the insulation is mounted on a passenger compartment side of an inner dash panel, noise may be reduced due to a hollow (pore) formed in the hollow sound absorption layer and, simultaneously, a thermal insulation effect may be obtained due to an air layer.

In addition, examples of a material used in an insulation include resin felt and glass wool.

Recently, a semi-rigid polyurethane foam has been applied to lighten an insulation. Such a semi-rigid polyurethane foam has sound absorption performance superior to that of resin felt or glass wool and can reduce weight, thereby improving fuel efficiency while reducing noise vibration.

However, semi-rigid polyurethane foam exhibits superior performance to resin felt or glass wool in middle and low frequency bands of 1,000 Hz or less, but this performance is relatively decreased in middle and high frequency bands.

### RELATED ART DOCUMENTS

### Patent Documents

(Patent Document 1) Korean Patent No. 1262609 (registered on May 2, 2013)

(Patent Document 2) Korean Patent Publication Application No. 10-2013-0080541 (published on Jul. 15, 2013)

### SUMMARY OF THE INVENTION

Therefore, the present disclosure has been made in view of the above problems, and it is an objective of the present disclosure to provide a method of manufacturing an insulation for automobiles capable of changing the cell structure of a foamed polyurethane foam by adding carbon nanotubes to a polyurethane foam sheet widely used as an insulation substrate, and thus, improving the NVH performance in a middle and high frequency band of 1,000 Hz or more while minimizing an increase in weight (lighter than resin felt or glass wool), and an insulation manufactured by the same.

In particular, it is another objective of the present disclosure to provide a method of manufacturing an insulation for automobiles capable of allowing noise to pass through at least one air layer in the middle of two polyurethane foam sheets when passing through the polyurethane foam sheets, due to the at least one air layer molded between the two polyurethane foam sheets, thereby further improving noise reduction performance, and an insulation manufactured by the same.

Further, it is still another objective of the present disclosure to provide a method of manufacturing an insulation for automobiles capable of further improving the sound absorption performance of an insulation by additionally providing a mesh made of jute, along with the at least one air layer, between the two polyurethane foam sheets, and an insulation manufactured by the same.

In accordance with the present disclosure, the above and other objectives can be accomplished by the provision of a method of manufacturing an insulation for automobiles, wherein a first polyurethane foam sheet 10, which is manufactured in a predetermined size according to a shape of an insulation mounted in an automobile and on which a nonwoven fabric is stacked on at least one side surface thereof; and a second polyurethane foam sheet 20, which faces the first polyurethane foam sheet 10, having at least one protrusion 21 protrusion-molded on a portion of an outer surface thereof which does not face the first polyurethane foam sheet, and a nonwoven fabric stacked on at least one surface thereof, are overlapped and subjected to first thermo-compression molding, and then second cold forming is performed to form at least one air layer 22 in at least one portion corresponding to the at least one protrusion 21, the method including a first step (S10) of respectively mixing and stirring the first and second polyurethane foam sheets 10 and 20 with 140 to 170 parts by weight of an isocyanate and 14.0 to 15.5 parts by weight of a filler containing carbon nanotubes based on 100 parts by weight of a polyol; a second step (S20) of injecting the solution of the polyol, the isocyanate, and the filler stirred in the step (S10) into a mold and foam-molding the same; and a third step (S30) of demolding the first and second polyurethane foam sheets 10 and 20 foam-molded in the mold.

In particular, the step (S10) may include step 1-1 (S11) of adding a filler containing carbon nanotubes to an isocyanate stock solution, followed by stirring the stock solution for 30 seconds; and step 1-2 (S12) of adding the stirred stock solution to a polyol stock solution, followed by stirring for 8 seconds.

Here, the isocyanate may contain 32.1% by weight of NCO, and in the filler, a weight ratio of a flame retardant (graphite) to carbon nanotubes may be 13.65:1.35 to 14.85:0.15.

In addition, the carbon nanotubes may have a diameter of 10 to 50 nm, a bulk density of 0.02 to 1.50 g/ml, a purity of 85 to 91%, a crystallinity (I_{G}/I_{D}) of 0.7 to 1.1.0, and a single wall or multiwall structure and are formed in a powder form or a powder granule form.

Meanwhile, the first and second polyurethane foam sheets may be further subjected to a fourth step (S40) of aging the first and second polyurethane foam sheets for 1 to 3 days after the foam-molding. Here, each of the first and second polyurethane foam sheets has a density of 14 to 17 kg/m³.

In addition, the nonwoven fabric may be a flame retardant nonwoven fabric, a general nonwoven fabric, or a reinforced/water repellent nonwoven fabric. Here, the flame retardant nonwoven fabric, the general nonwoven fabric, or the reinforced/water repellent nonwoven fabric may have a weight per unit area of 100 to 200 g/m².

In addition, the thermo-compression molding may be performed at 160 to 190° C. for 30 seconds to 4 minutes, and the cold forming may be compression cooling performed in a cooling jig for 30 to 60 seconds.

In addition, a jute mesh may be inserted between the first and second polyurethane foam sheets, followed by integrally molding the same.

Meanwhile, the present disclosure includes an insulation for automobiles manufactured according to the method, and aluminum & glass cloth (ALGC) may be partially attached to the insulation.

Finally, the insulation may be mounted on a dash panel and a hood.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a side view schematically illustrating the positions of insulations mounted on a dash panel and a hood of an automobile;

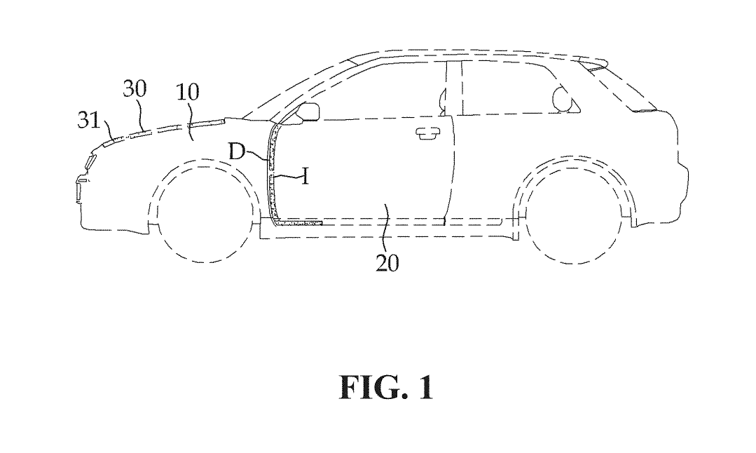

FIG. 2 is an image illustrating a general example of an insulation mounted on a dash panel;

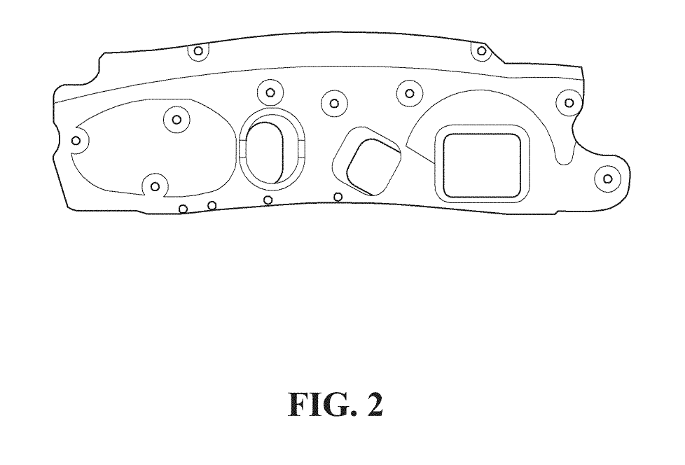

FIG. 3 is an image illustrating a general example of an insulation mounted on a hood;

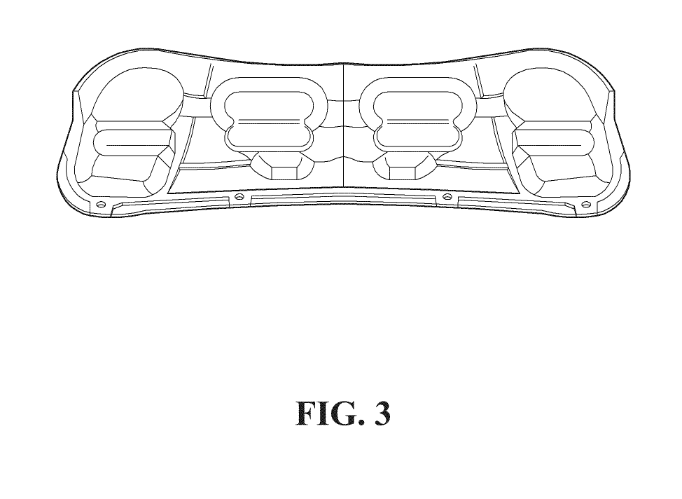

FIG. 4 is a flowchart illustrating a method of manufacturing a polyurethane foam sheet according to the present disclosure;

FIGS. 5A-5B illustrates photographs of enlarged surfaces of polyurethane foam sheets observed by a scanning electron microscope (FIG. 5A illustrates an enlarged photograph of a conventional polyurethane foam sheet, and FIG. 5B illustrates an enlarged photograph of a polyurethane foam sheet to which carbon nanotubes are added);

FIG. 6 is a flowchart illustrating a method of manufacturing an insulation according to the present disclosure;

FIG. 7 is a graph illustrating sound absorption performance test data of polyurethane foam sheets according to the present disclosure dependent upon the content of carbon nanotubes (CNTs);

FIG. 8 is a graph illustrating sound absorption performance test data of a polyurethane foam sheet including carbon nanotubes (CNTs) according to the present disclosure and sheets according to Comparative Examples 1 to 3 in which materials different from that of the present disclosure are used;

FIGS. 9A and 9B are graphs illustrating transmitted noise test results of a polyurethane foam sheet (example), to which carbon nanotubes are applied, and a polyurethane foam sheet (comparative example), to which carbon nanotubes are not applied, in automobiles;

FIGS. 10A and 10B illustrate exemplary photographs of a first polyurethane foam sheet (upper drawing) and a second polyurethane foam sheet (lower drawing) according to the present disclosure;

FIGS. 11A-11C are sectional views illustrating a process of molding first and second polyurethane foam sheets according to the present disclosure through thermopressing, and then cold forming the same, thereby forming an air layer;

FIG. 12A and 12B illustrates photographs of an insulation including an air layer that is formed by molding first and second polyurethane foam sheets according to the present disclosure through thermopressing, and then cold forming the same;

FIGS. 13A and 13B illustrate graphs of accelerated transmission noise measured at driver's seats (left drawing) and passenger's seats (right drawing) of automobiles on which an insulation (example) manufactured using a polyurethane foam sheet according to the present disclosure and an insulation (comparative example) manufactured using a conventional polyurethane foam sheet are directly mounted;

FIG. 14 is a sectional view illustrating a configuration including jute meshes that is added between first and second polyurethane foam sheets according to the present disclosure; and

FIG. 15 is a graph illustrating individual test results of an example including jute meshes according to the present disclosure and Comparative Examples 1 to 3 formed of materials different from the example of the present disclosure.

### DETAILED DESCRIPTION OF EXEMPLARY EMBODIMENTS

Hereinafter, preferred embodiments of the present disclosure will be described more fully with reference to the accompanying drawings. Terms or words used herein shall not be limited to common or dictionary meanings, and have meanings and concepts corresponding to technical aspects of the embodiments of the present disclosure so as to most suitably express the embodiments of the present disclosure.

Accordingly, the configurations of examples and drawings disclosed in the present specification are merely preferred embodiments of the present disclosure and do not represent the full technical spirit of the present disclosure. Therefore, it should be understood that various equivalents and modifications may have been present at a filing time of the present application.

### Method of Manufacturing Insulation

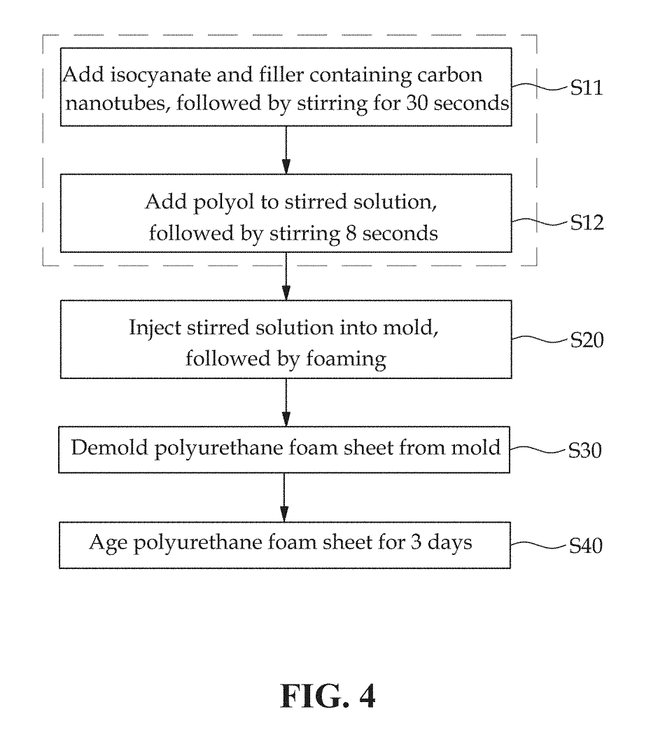

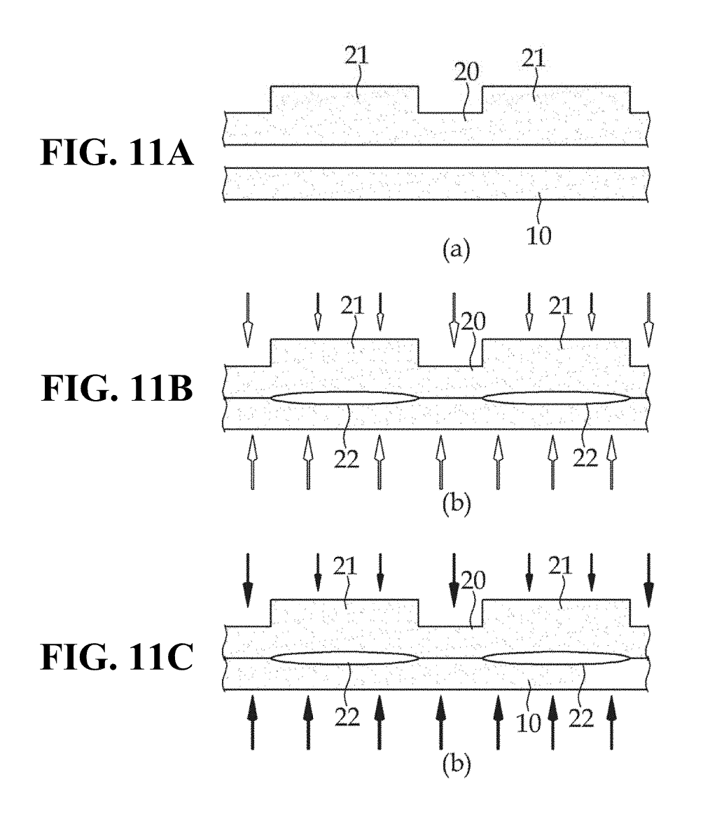

A method of manufacturing an insulation for automobiles according to the present disclosure is characterized by bringing first and second polyurethane foam sheets 10 and 20 manufactured according to FIGS. 4 and 11 into contact with each other, and then performing hot forming (thermo-compression molding) through thermopressing, followed by cold forming.

In particular, by protrusion-molding at least one protrusion 21 thicker than the second polyurethane foam sheet 20 on a surface, which does not face the first polyurethane foam sheet 10, of the second polyurethane foam sheet 20, less heat is transferred to the at least one protrusion 21, compared to other portions, upon thermomolding, whereby the first and second polyurethane foam sheets 10 and 20 are not easily attached to each other. Accordingly, at least one air layer 22 is formed between the first and second polyurethane foam sheets 10 and 20, whereby noise blocking performance may be improved.

In addition, since the first and second polyurethane foam sheets 10 and 20 contain carbon nanotubes, a cell structure of the polyurethane foam sheet is changed. Accordingly, the weight of an insulation may be reduced and sound absorption performance may be improved.

In addition, a jute mesh 23 is additionally provided between the first and second polyurethane foam sheets 10 and 20, whereby sound absorption performance may be further improved.

Hereinafter, the method of manufacturing an insulation according to the present disclosure is described in more detail with reference to the accompanying drawings. Here, for convenience of explanation, a process of manufacturing the polyurethane foam sheet constituting the first and second polyurethane foam sheets of the present disclosure is first described, and then the method of manufacturing the insulation according to the present disclosure is described.

### Manufacture of Polyurethane Foam Sheet

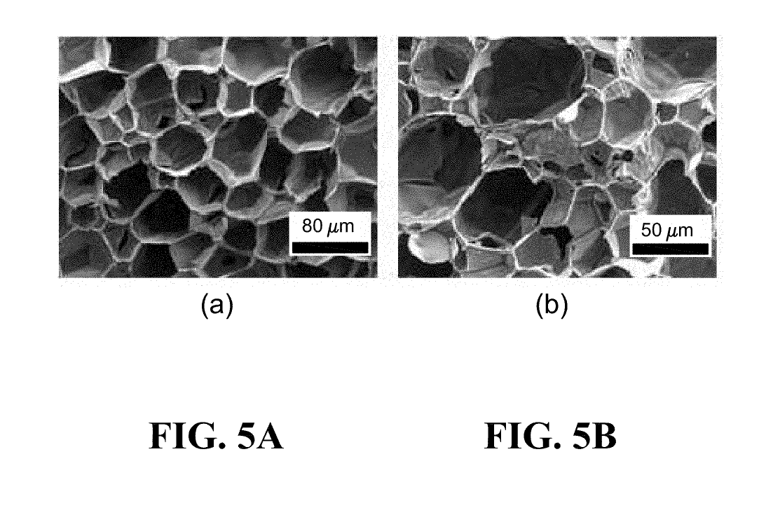

With regard to the method of manufacturing a polyurethane foam sheet according to the present disclosure, as illustrated in FIGS. 4 and 5A/5B, a method of foam-molding a polyurethane foam is performed in three steps. Hereinafter, the steps are respectively described in more detail (see Korean Patent Application Publication No. 10-2015-0029309).

S10 is a step of mixing and stirring a polyol, an isocyanate, and a filler as illustrated in FIG. 4. Here, 140 to 170 parts by weight of the isocyanate and 14.0 to 15.5 parts by weight of the filler are mixed and stirred based on 100 parts by weight of the polyol.

Hereinafter, the stirred polyol, isocyanate, and filler are described in more detail.

As the isocyanate, MDI (Methylene Diphenyl di Isocyanate) may be used so as to obtain a rigid polyurethane foam sheet, preferably a semi-rigid polyurethane foam sheet. Preferably, MDI containing 32.1% by weight of NCO is used, thereby manufacturing a semi-rigid polyurethane foam sheet and, accordingly, maximally increasing sound absorption performance.

The filler includes a flame retardant (graphite) for exhibiting a flame retarding effect and carbon nanotubes for improving sound absorption performance. In particular, a weight ratio of the flame retardant to the carbon nanotubes is preferably 13.65:1.35 to 14.85:0.15, whereby sound absorption performance may be maximized by changing the cell structure of the polyurethane foam, as described below, while minimizing the content of the carbon nanotubes, which are separately added in addition to components used upon manufacture of a conventional polyurethane foam.

In a preferred example of the present disclosure, the carbon nanotubes may have a diameter 10 to 50 nm, a bulk density of 0.02 to 1.50 g/ml, a purity of 85 to 91%, a crystallinity (I_{G}/I_{D}) of 0.7 to 1.1.0, and a single wall or multiwall structure. In addition, the carbon nanotubes may be manufactured in a powder from to be added to the flame retardant. Alternatively, the carbon nanotubes may be manufactured in a powder granule form to be added to the flame retardant.

The polyol, the isocyanate, and the filler are stirred twice as illustrated in FIG. 4. Here, a weight ratio thereamong has been described, and thus, detailed description thereof is omitted.

Step 1-1 (S11), as a first stirring step, is a step of adding a filler to an isocyanate stock solution and stirring the same. Here, the stirring is performed for 30 seconds. Step 1-2 (S12), as a second stirring step, is a step of adding the isocyanate stock solution stirred in step 1-1 (S11) to a polyol stock solution, followed by stirring for 8 seconds.

By such two-step stirring, a stirring step for molding a foamable polyurethane foam is substantially completed. Such a stirring step is the same as or similar to a general foaming process, but, in the present disclosure, carbon nanotubes are further added to the stirred stock solution.

A second step (S20) is a step of injecting the solution stirred in step S10 into a mold for foaming to perform foam-molding, as illustrated in FIG. 4. The foam-molding is carried out by means of a mold for foaming. This mold for foaming may be variously manufactured considering the size, the shape, and the like of the polyurethane foam sheet.

That is, the mold for foaming may be manufactured according to the size and the shape of a polyurethane foam sheet which is a substrate of an insulation, and thus, the polyurethane foam sheet may be foam-molded one by one in one mold for foaming Alternatively, a mold for foaming may be manufactured to foam-mold the polyurethane foam sheet in a block shape, and the block may be sliced according to the size of an insulation. In the present disclosure, an example of foam-molding a stirred solution in a block shape and slicing the foam-molded product, followed by cutting the same into a panel shape, is described.

A third step (S30) is a step of demolding the polyurethane foam sheet from the mold for foaming, as illustrated in FIG. 4. Such demolding is performed according to general techniques, and thus, detailed description thereof is omitted.

Meanwhile, in a preferred example of the present disclosure, a fourth step (S40) of, after foam-molding the polyurethane foam sheet in the mold for foaming, aging the polyurethane foam sheet may be further performed, as illustrated in FIG. 4. This step is provided to sufficiently cool the polyurethane foam sheet foam-molded in a block shape, as described above.

Here, the aging may be varied depending upon the size, the volume, and the like of the polyurethane foam sheet block. In a preferred example of the present disclosure, the aging is performed for 1 to 3 days.

Comparing the polyurethane foam sheet (see FIG. 5B) according to the present disclosure manufactured as described above with a conventional sheet, to which carbon nanotubes are not added, as illustrated in FIG. 5A, it can be confirmed that the cell structure constituting the semi-rigid polyurethane foam sheet according to the present disclosure is uniform and a cell open rate is increased. That is, the hardness of the polyurethane foam sheet is decreased, and thus, a damping function is improved, whereby the NVH performance is significantly improved in the entire frequency band. The NVH performance is described with reference to the graphs of the insulation tested in an automobile.

Here, a semi-rigid polyurethane foam has a cell structure similar to that of a rigid polyurethane foam, but, while the rigid polyurethane foam has a closed cell structure and, accordingly, has a heat insulation property and a cold insulation property, the cell structure of the semi-rigid polyurethane foam is a partially open mesh structure, as illustrated in FIGS. 5A and 5B. Accordingly, the semi-rigid polyurethane foam cancels out sound waves, which cause noise, passing through the cell structure, thereby having an excellent NVH performance effect. However, when the cell structure is completely opened, the sound waves do not pass through the polyurethane foam and thus are not canceled out, whereby a noise reduction effect cannot be obtained. Accordingly, in the present disclosure, the open rate of the cell structure is controlled to accomplish noise reduction according to a specific frequency band matching properties required in a position where the insulation is mounted. Such control may be accomplished due to the structure of a stock solution, such as a polyol, and the composition of other additives. In the present disclosure, the open rate of the cell structure is adjusted to a desired noise frequency band by additionally adding additives, particularly carbon nanotubes.

More particularly, FIGS. 5A and 5B illustrate an enlarged surface of a foamed polyurethane foam observed by means of a scanning electron microscope. From this image, it can be confirmed that there is a change in the cell structure. In addition, due to such a cell structure change, the open rate of the cell structure was changed, and consequent flow resistance was measured using a flow resistance meter. As a result, the foamed polyurethane foam, to which carbon nanotubes were applied, exhibited a lower resistance value, compared to a foam to which carbon nanotubes were not applied. This was caused by improvement of the air permeability of the foamed polyurethane foam, to which carbon nanotubes were applied. Accordingly, the sound absorption performance was significantly improved due to the uniform cell structure and the improved air permeability effect.

Results of inductive resistance measurement to measure air permeability are summarized in Table 1 below:

TABLE 1

| Classification | Measured values |
|---|---|
| Comparative example | 539518 |
| Example | 321599 |

1) In the comparative example, a polyurethane foam not containing carbon nanotubes (CNTs) is used.
2) In the example, a polyurethane foam containing carbon nanotubes (CNTs) is used.
3) The unit of a measured value is “mks ravl/m”.

### Manufacture of Insulation

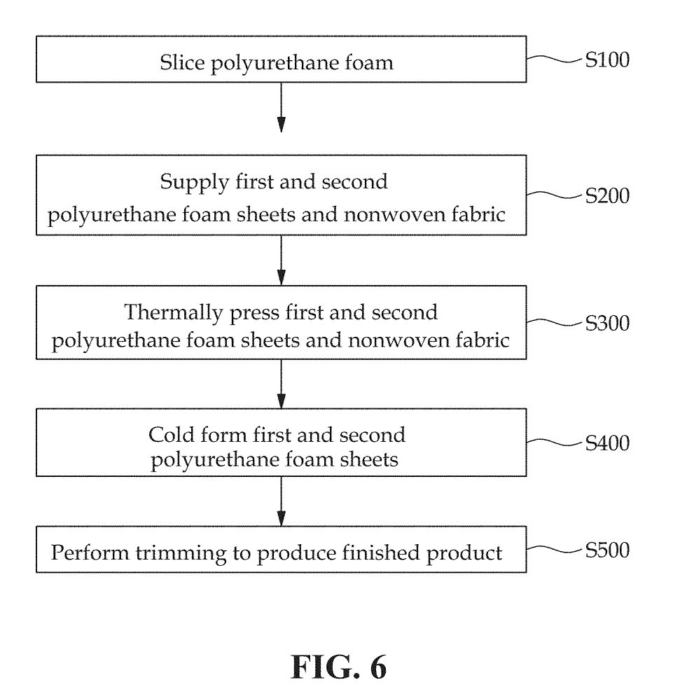

In the method of manufacturing the insulation according to the present disclosure, the first and second polyurethane foam sheets 10 and 20 having the same constitution as that of the aforementioned polyurethane foam sheet were used as illustrated in FIGS. 6 to 11. The method consists of five steps is as illustrated in FIG. 6. Hereinafter, each step is described in detail. In the drawing, thin arrows indicate the direction of compression applied upon hot forming, and thick arrows indicate the direction of compression applied upon cold forming. In addition, the sizes of arrows indicate a heat transfer degree transferred to a surface facing the polyurethane foam sheet. Here, larger arrows indicate that more heat transfer occurs.

A first step (S100) is a step of slicing a polyurethane foam sheet manufactured by foam-molding according to the aforementioned method as illustrated in FIG. 6. Here, the polyurethane foam sheet was foam-molded in a block shape as described above, and carbon nanotubes were added thereto.

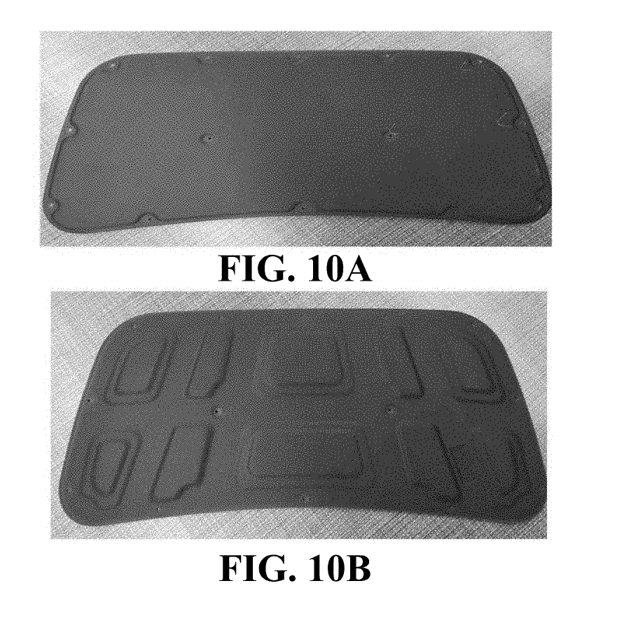

Here, the slicing is a process of cutting the polyurethane foam sheet with a block shape to a thickness and width required in an actual insulation. Here, by the cutting, the first and second polyurethane foam sheets 10 and 20 have shapes as illustrated in FIGS. 10A and 10B and 11A-11C. In particular, the first polyurethane foam sheet 10 is cut into a flat shape, as illustrated in an upper drawing of FIG. 10A and FIG. 11A, and the second polyurethane foam sheet 20 is protrusion-molded to have at least one protrusion 21 on one surface thereof as illustrated in a lower drawing of FIG. 10B and FIG. 11A.

Here, the at least one protrusion 21 is protrusion-molded on a surface of the second polyurethane foam sheet 20 not facing the first polyurethane foam sheet 10, as illustrated in FIG. 11A-11C. The at least one air layer 22 is formed when stacking the first and second polyurethane foam sheets 10 and 20 and thermally pressing the same. The at least one air layer 22 is described in detail when third and fourth steps (S300 and S400) are described below.

Meanwhile, the at least one protrusion 21 is provided to reduce noise by forming the at least one air layer 22 and thus allowing noise to pass through the at least one air layer 22. In particular, the at least one protrusion 21 is protrusion-molded to form the at least one air layer 22 because the thicknesses of the first and second polyurethane foam sheets 10 and 20 alone cannot sufficiently reduce noise or a certain insulation portion is inevitably exposed to loud noise.

The first step (S100) is unnecessary when the polyurethane foam sheet is molded into the first and second polyurethane foam sheets 10 and 20 in the aforementioned manufacturing method, but is necessary when the polyurethane foam sheet is formed in a block shape.

A second step (S200) is a process of providing a sliced polyurethane foam sheet and a nonwoven fabric to a mold for thermomolding as illustrated in FIG. 6. Here, the mold for thermomolding is a mold manufactured according to a general technique for molding an object in a predetermined shape by applying both heat and pressing to the object.

Such a mold for thermomolding is manufactured in a desired shape. For example, the mold is manufactured to have a plate-shaped or insulation-shaped cavity, and a sliced polyurethane foam sheet and a nonwoven fabric are supplied to the cavity. In addition, the mold for thermomolding is selected considering the shrinkage of a nonwoven fabric. In the case of such a nonwoven fabric, a mold for thermomolding is selected considering a shrinkage of about 14/1000 (mm).

Here, as examples of a nonwoven fabric, a general nonwoven fabric, a flame retardant nonwoven fabric, a reinforced/water repellent nonwoven fabric, or the like may be used. Since required insulation properties are different for each company, a nonwoven fabric may be selected considering the strength of an insulation meeting such requirements. The reinforced/water repellent nonwoven fabric is manufactured by increasing the amount of low melting fiber (LMF), compared to a conventional nonwoven fabric, to improve rigidity and adding a water repellent to a surface thereof to improve the resistance to humidity.

Meanwhile, in the second step (S200), a nonwoven fabric is supplied to a mold for thermomolding when the first and second polyurethane foam sheets 10 and 20 are supplied to the mold for thermomolding. Here, the nonwoven fabric may be respectively supplied to both surfaces of the first and second polyurethane foam sheets 10 and 20, or may be supplied so as to be integrally attached to only an outer surface of the insulation molded using the first and second polyurethane foam sheets 10 and 20.

The nonwoven fabric used in the second step (S200), most preferably, has a weight per unit area of 100 to 200 g/m².

The third step (S300) is a step of stacking the supplied first and second polyurethane foam sheets 10 and 20 and thermally pressing the same to perform hot forming, as illustrated in FIGS. 6 and 11B. Here, the thermally pressing is performed in the aforementioned mold for thermomolding. The thermally pressing is performed within temperature and time ranges in which the sliced polyurethane foam sheet and nonwoven fabric are not destroyed by heat and pressure. In a preferred example of the present disclosure, the thermally pressing is performed at 160 to 190° C. for 30 seconds to 4 minutes.

Here, the nonwoven fabric is respectively stacked on both surfaces of the first and second polyurethane foam sheets 10 and 20 or is stacked on one outwardly exposed surface when an insulation is manufactured, and then thermally pressed, as described above, so as to provide functions, such as strength and removal of moisture and water drops, according to required insulation properties.

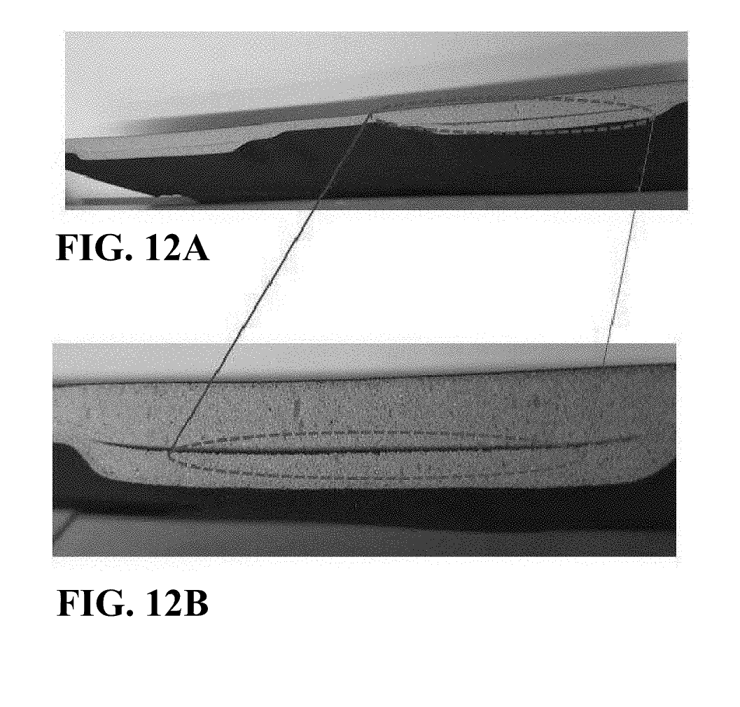

Meanwhile, when the first and second polyurethane foam sheets 10 and 20 are thermally pressed as described above, the at least one air layer 22 is formed at an interface where the first and second polyurethane foam sheets 10 and 20 come into contact with each other, as illustrated in FIGS. 11B and 12A-B, because heat is not satisfactorily transferred, due to the thick thickness of the at least one protrusion 21, to portions of the first polyurethane foam sheet 10, which correspond to the at least one protrusion 21 formed in the second polyurethane foam sheet 20, when the first and second polyurethane foam sheets 10 and 20 are thermally molded at the same temperature. That is, heat applied to the second polyurethane foam sheet 20 is not transferred to the first polyurethane foam sheet 10 due to the thickness of the at least one protrusion 21, whereby the first and second polyurethane foam sheets 10 and 20 are not attached to each other, resulting in the formation of the at least one air layer 22. Noise passes through the at least one air layer 22 before sequentially passing through the first and second polyurethane foam sheets 10 and 20, whereby the noise may be reduced.

The fourth step (S400) is a step of performing thermopressing and then performing cold forming as illustrated in FIGS. 6 and 11C. In the cold forming, compression cooling is performed in a cooling jig for 30 to 60 seconds, thereby forming a semi-completed product. The cooling jig may be a cooling jig manufactured according to a general technique. A cooling condition of the cooling jig is preferably determined considering the possibility of shrinkage of a nonwoven fabric upon cooling as in the aforementioned mold for thermomolding.

In particular, the cold forming is performed to maintain the at least one air layer 22 formed between the first and second polyurethane foam sheets 10 and 20 by rapidly and sufficiently cooling the first and second polyurethane foam sheets 10 and 20 thermally pressed in the aforementioned third step S300.

A fifth step S500 is a step of trimming the cooled semi-completed product to complete an insulation, as illustrated in FIG. 6. Such a trimming process is performed according to a general method, and thus, detailed description thereof is omitted.

Although the sound absorption effect of a sound-absorbing material is generally known as being superior with an increasing density thereof, the polyurethane foam sheet for insulation manufactured as described above preferably has a density of 14 to 17 kg/m³, whereby the sound absorption effect with respect to weight may be further improved as a preferred example of the present disclosure.

### Insulation

The present disclosure includes an insulation manufactured according to the aforementioned method of manufacturing an insulation. In particular, the insulation is mounted on a dash panel, a headliner, and a hood.

Hereinafter, the properties of a polyurethane foam sheet having the same constitution as the first and second polyurethane foam sheets of the present disclosure are first described, and then the properties of an insulation manufactured using such polyurethane are described in detail.

### Comparison of Property Values of Polyurethane Foam Sheets

Table 2 and FIGS. 5A-B show property values of (a) a polyurethane foam sheet of the comparative example in which a polyurethane foam sheet to which carbon nanotubes were not added was used, and (b) polyurethane foam sheets of Examples 1 to 3 according to the present disclosure in which the addition amount of carbon nanotubes was varied.

As shown Table 2, the content of carbon nanotubes (CNTs) is 0.1% by weight in Example 1, the content of carbon nanotubes (CNTs) is 0.3% by weight in Example 2, and the content of carbon nanotubes (CNTs) is 0.5% by weight in Example 3. In addition, in the comparative example, carbon nanotubes were not added.

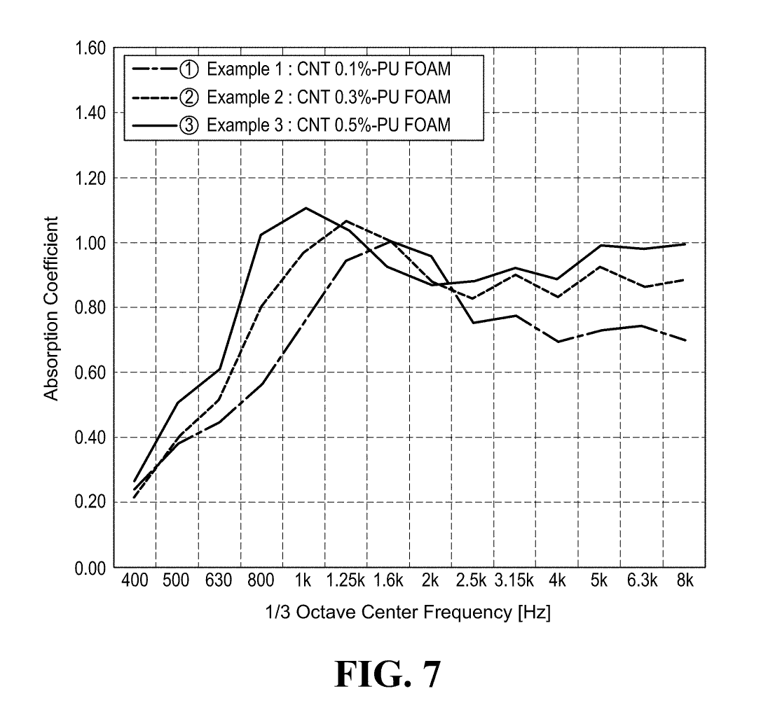

Here, it can be confirmed that, in Examples 1 to 3, although the density is small, the NVH performance is better with an increasing content of CNTs, as shown in Table 2 and FIG. 7 illustrating sound absorption performance per the content of CNTs. In addition, it can be confirmed that other property values are similar to or the same as those of the comparative example.

In addition, it can be confirmed that, in the case of Examples 1 to 3, tensile strength, flexural strength, and elongation are high, compared to the comparative example. Such results may be due to improved stiffness of the polyurethane foam. Such stiffness improvement improves the adhesion to an automobile body and the damping performance, thereby improving the sound absorption performance.

In FIG. 7, a horizontal axis represents frequency, and a vertical axis represents sound absorption rate.

### NVH Performance Comparison Between Polyurethane Foam Sheet and Different Materials

In Table 3 below, the weights and NVH performance of a sheet of an example, to which the reinforced/water repellent nonwoven fabric according to the present disclosure and carbon nanotubes were applied, and sheets of Comparative Examples 1 to 3, to which various materials and a nonwoven fabric were applied, were compared.

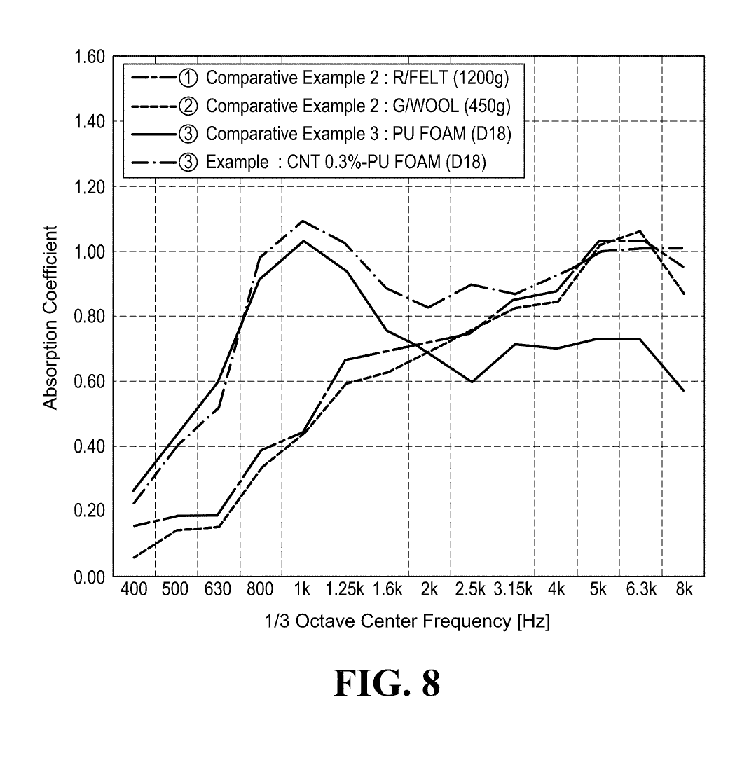

Sound absorption performance measurement results of Comparative Examples 1 to 3 and the example shown in Table 3 may be confirmed in FIG. 8. In FIG. 8, a horizontal axis represents frequency, and a vertical axis represents sound absorption rate.

As illustrated in FIG. 8, it can be confirmed that the foamed polyurethane foam according to the example is heavy, compared to the comparative examples, particularly the resin felt, but by adding a small amount of carbon nanotubes, the NVH performance (sound absorption performance) is superior over the entire band, compared to Comparative Examples 1 to 3, although actual weight increase in the example is small.

Accordingly, the foamed polyurethane foam according to the present disclosure exhibits improved sound absorption performance with a little increase in the weight thereof, compared to a conventional foamed polyurethane foam widely applied to insulations in recent years.

### Transmitted Noise Test for Polyurethane Foam Sheet In Automobile

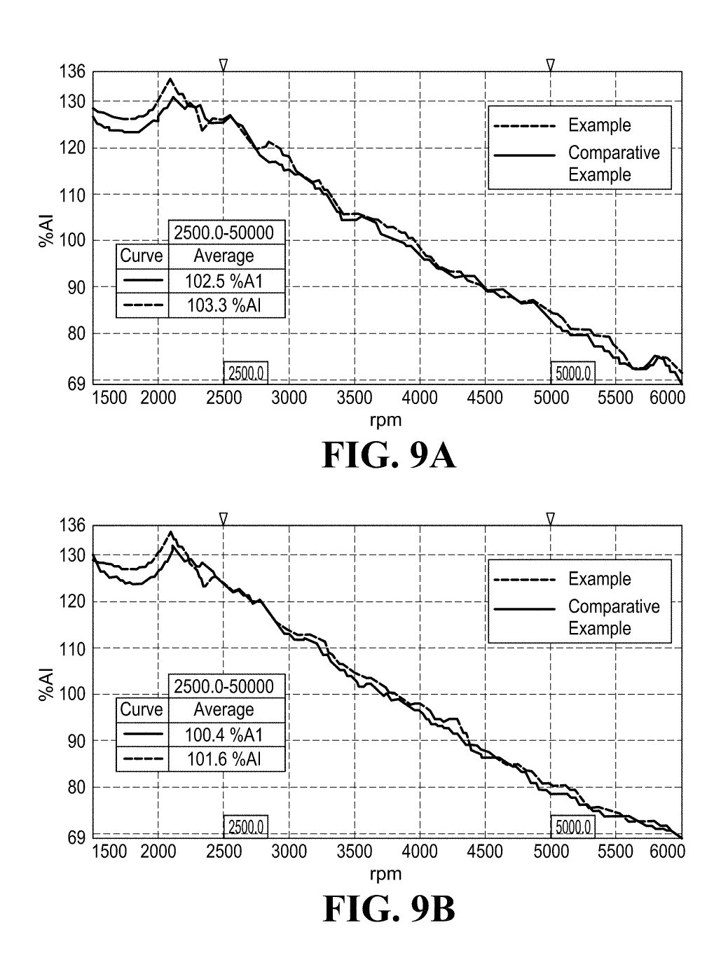

FIGS. 9A and 9B illustrate transmitted noise (% AI) results measured in an automobile. In the graphs, a horizontal axis represents speed (rpm), a vertical axis represents transmitted noise (% AI), FIG. 9A shows results measured in a driver's seat, and FIG. 9B shows results measured in a passenger's seat.

From the graphs, it can be confirmed that, in the case of the example, a transmitted noise effect is superior in almost all the speed sections, compared to the comparative example. In particular, it can be confirmed that the transmitted noise effect is improved by 0.8% on average in a driver's seat and is improved by 1.2% on average in a passenger's seat.

### Acceleration Transmitted Noise Test for Insulation

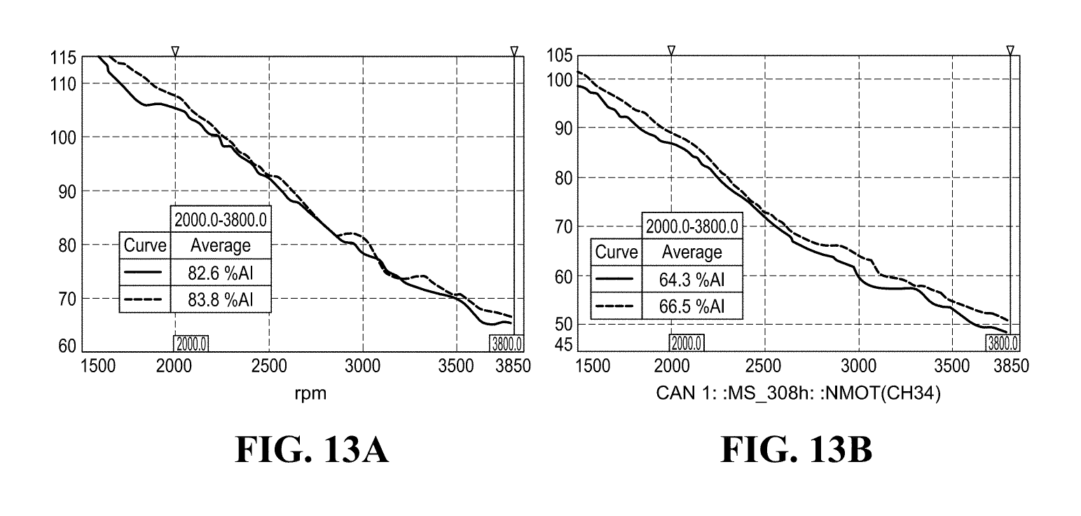

FIGS. 13A and 13B illustrate graphs of acceleration transmitted noise measured at driver's seats (left drawing) and passenger's seats (right drawing) of automobiles in which an insulation (example) manufactured using a polyurethane foam sheet according to the present disclosure and an insulation (comparative example) manufactured using a conventional polyurethane foam sheet are directly mounted. Here, acceleration transmitted noise refers to noise measured in a driver's seat and a passenger's seat when a transmission is in third gear and an accelerator pedal is fully depressed.

In FIGS. 13A and 13B, a horizontal axis represents the number of revolutions (rpm) of a vehicle, a vertical axis represents acceleration transmitted noise (% AI), a red line represents the example, and a black line represents the comparative example. Examining results measured in a driver's seat, it can be confirmed that the acceleration transmitted noise of the example is higher than that of the comparative example with an increasing revolution number. In particular, when average values are compared in an interval of 2,000 to 3,800 rpm, it can be confirmed that the % AI of the comparative example is 82.6% AI and the % AI of the example is 83.8% AI, which indicates that the acceleration transmitted noise in the example is improved by 1.2% AI compared to that in Comparative Example.

In addition, examining results measured in a passenger's seat illustrated in FIGS. 13A and 13B, it can be confirmed that the acceleration transmitted noise of the example is higher than that of the comparative example with an increasing revolution number. In particular, when average values are compared in an interval of 2,000 to 3,800 rpm, it can be confirmed that the % AI of the comparative example is 64.3% AI and the % AI of the example is 66.5% AI, which indicates that the acceleration transmitted noise in the example is improved by 2.2% AI compared to that in Comparative Example.

### Modified Example of Insulation

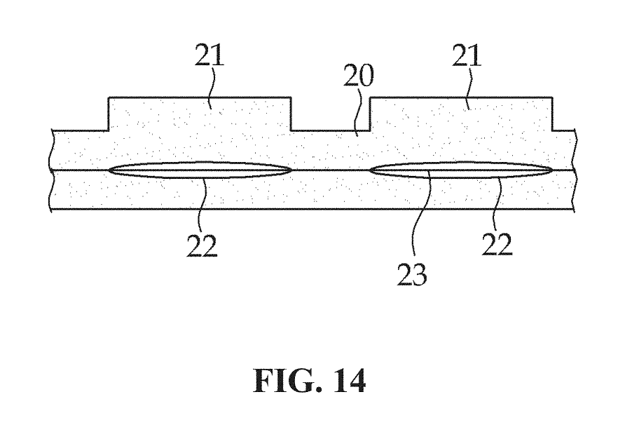

A modified example of the insulation according to the present disclosure further includes the jute mesh 23 as illustrated in FIG. 14. That is, FIG. 14 is a sectional view illustrating a configuration including jute meshes that is added between first and second polyurethane foam sheets according to the present disclosure. Here, the jute mesh 23 is inserted between the first and second polyurethane foam sheets 10 and 20 before thermopressing is performed, and then is integrally pressed along with the first and second polyurethane foam sheets 10 and 20 to be integrally molded.

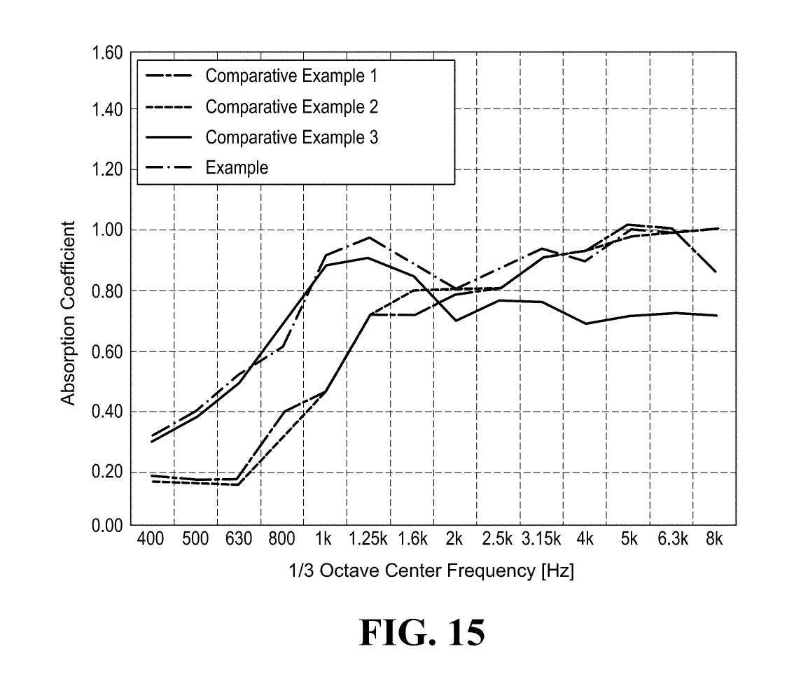

The jute mesh 23 inserted therebetween and integrally hot-formed along with the first and second polyurethane foam sheets 10 and 20 was manufactured in a grid form using jute as illustrated in FIG. 14. In particular, the jute mesh 23 is located in the middle of the at least one air layer 22, and thus, energy is absorbed by the resonance of the jute grid, thereby increasing a high-frequency sound absorption rate with respect to noise passing through the at least one air layer 22. FIG. 15 is a graph illustrating individual test results of an example including jute meshes according to the present disclosure and Comparative Examples 1 to 3 formed of materials different from the example of the present disclosure. In Table 4 below, layer compositions of the sheets of the example and Comparative Examples 1 to 3 are summarized.

TABLE 4

| Classification | Layer composition | | |
|---|---|---|---|
| Comparative | Nonwoven | Glass wool | Nonwoven |
| Example 1 | fabric | (600 g, | fabric |
| | (100 g) | 20 mm) | (100 g) |
| Comparative | Nonwoven | Resin felt | Nonwoven |
| Example 2 | fabric | (200 g, | fabric |
| | (100 g) | 20 mm) | (100 g) |
| Comparative | Nonwoven | Polyurethane | Nonwoven |
| Example 3 | fabric | foam | fabric |
| | (100 g) | (20 mm) | (100 g) |
| Example | Flame- | CNT PU | Flame- |
| | retardant | foam | retardant |
| | nonwoven | sheet | nonwoven |
| | fabric | | fabric |
| | (100 g) | | (100 g) |

1) The CNT PU foam sheet was manufactured according to the present disclosure.
A jute mesh was inserted into the CNT PU foam sheet to form air gaps. The CNT PU foam sheet was manufactured to a thickness of 20 mm.

In FIG. 15, a horizontal axis represents the frequency (⅓ Octave Frequency [Hz]), a vertical axis represents sound absorption rate (absorption coefficient), a yellow graph represents Comparative Example 1, a green graph represents Comparative Example 2, a black graph represents Comparative Example 3, and a red graph represents the example. Referring to FIG. 15, the example mostly exhibits high sound absorption performance in the entire frequency range, but Comparative Examples 1 and 2 exhibit sound absorption performance lower than the example in a low frequency range and exhibit sound absorption performance similar to the example in a high frequency range. On the contrary, Comparative Example 3 exhibits sound absorption performance similar to the example in a low frequency range, but exhibits sound absorption performance lower than the example in a high frequency range.

The insulation according to the present disclosure constituted as described above may be installed in various places in an automobile such as a dash panel, a headliner, and a hood, as described above.

Here, the insulation according to the present disclosure may be manufactured to have various properties according to characteristics required in various places. In particular, when a mounting location is exposed to high temperature as in a hood, it is preferred to entirely or partially mount aluminum & glass cloth (ALGC) on an insulation. ALGC is made by combining glass fiber mesh with aluminum. In the present disclosure, ALGC, which has excellent radiant heat blocking performance, in which low tensile and tear strength, as a weak point of aluminum, is improved, and which is manufactured by a general technique, is used.

As described above, the method of manufacturing an insulation for automobiles according to the present disclosure and the insulation manufactured by the method have effects as follows:

(1) The cell structure of a foamed polyurethane material is changed by adding carbon nanotubes (CNTs) and then performing foam-molding upon manufacture of a polyurethane foam sheet, thereby transmission performance thereof is improved and, accordingly, sound absorption performance, compared to a weight increase, as a sound absorption material can be maximized.

(2) In particular, since carbon nanotubes are only added in a conventional manufacturing process of manufacturing a polyurethane foam sheet, the addition of a process is minimized and an increase in manufacturing costs can be reduced.

(3) Since the internal structure of the polyurethane foam sheet is changed due to the added carbon nanotubes, sound absorption performance can be significantly improved in all frequency ranges while retaining the benefit, i.e., reduction of the weight of an automobile, of the polyurethane foam material, compared to other sound absorption materials for an engine compartment.

(4) Accordingly, by adding a small amount of carbon nanotubes, the NVH performance can be maximized and, accordingly, interior quietness of an automobile can be greatly improved while minimizing a rise in costs;

(5) Meanwhile, since two polyurethane foam sheets are brought into contact with each other, thermally pressed, and cold formed, at least one protrusion, which is thicker than the polyurethane foam sheet, is formed on any one of the polyurethane foam sheets, at least one air layer is formed in at least one portion of the polyurethane foam sheet corresponding to the at least one protrusion, whereby noise passes through the two polyurethane foam sheets and the at least one air layer and, accordingly, noise reduction performance can be further improved; and

(6) In addition, by inserting a jute mesh between the two polyurethane foam sheets and integrally molding the same upon manufacture of an insulation, a high-frequency sound absorption rate can be increased.

It will be apparent to those skilled in the art that various modifications can be made to the above-described exemplary embodiments of the present disclosure without departing from the spirit or scope of the present disclosure. Thus, it is intended that the present disclosure covers all such modifications provided they come within the scope of the appended claims and their equivalents.

### DESCRIPTION OF SYMBOLS

10, 20: First and second polyurethane foam sheets

21: Protrusion

22: Air layer

23: Jute mesh

What is claimed is:

1. A method of manufacturing an insulation for automobiles, wherein a first polyurethane foam sheet, which is manufactured in a predetermined size according to a shape of an insulation mounted on an automobile and comprises a nonwoven fabric stacked on one-side surface thereof; and a second polyurethane foam sheet, which faces the first polyurethane foam sheet, on a portion of an outer surface which of not facing the first polyurethane foam sheet at least one protrusion is protrusion-molded, and on at least one surface of which a nonwoven fabric is stacked, are overlapped and subjected to first thermo-compression molding, and then second cold forming is preformed to form at least one air layer in at least one portion corresponding to the at least one protrusion, the method comprising a first step (S10) of respectively mixing and stirring the first and second polyurethane foam sheets with 140 to 170 parts by weight of an isocyanate and 14.0 to 15.5 parts by weight of a filler containing carbon nanotubes based on 100 parts by weight of a polyol; a second step (S20) of injecting the solution of the polyol, the isocyanate, and the filler stirred in the step (S10) into a mold and foam-molding the same; and a third step (S30) of demolding the first and second polyurethane foam sheets foam-molded in the mold.

2. The method according to claim 1, wherein the step (S10) comprises:
step 1-1 (S11) of adding a filler containing carbon nanotubes to an isocyanate stock solution, followed by stirring the stock solution for 30 seconds; and
step 1-2 (S12) of adding the stirred stock solution to a polyol stock solution, followed by stirring for 8 seconds.

3. The method according to claim 1, wherein the isocyanate contains 32.1% by weight of NCO.

4. The method according to claim 1, wherein, in the filler, a weight ratio of a flame retardant (graphite) to carbon nanotubes is 13.65:1.35 to 14.85:0.15.

5. The method according to claim 4, wherein the carbon nanotubes have a diameter of 10 to 50 nm, a bulk density of 0.02 to 1.50 g/ml, a purity of 85 to 91%, a crystallinity (I_{G}/I_{D}) of 0.7 to 1.1.0, and a single wall or multiwall structure and are formed in a powder form or a powder granule form.

6. The method according to claim 1, wherein the first and second polyurethane foam sheets are further subjected to a fourth step (S40) of aging the first and second polyurethane foam sheets for 1 to 3 days after the foam-molding.

7. The method according to claim 1, wherein each of the first and second polyurethane foam sheets has a density of 14 to 17 kg/m³.

8. The method according to claim 1, wherein the nonwoven fabric is a flame retardant nonwoven fabric, a general nonwoven fabric, or a reinforced/water repellent nonwoven fabric.

9. The method according to claim 1, wherein the flame retardant nonwoven fabric, the general nonwoven fabric, or the reinforced/water repellent nonwoven fabric has a weight per unit area of 100 to 200 g/m².

10. The method according to claim 1, wherein the thermo-compression molding is performed at 160 to 190° C. for 30 seconds to 4 minutes.

11. The method according to claim 1, wherein the cold forming is compression cooling performed in a cooling jig for 30 to 60 seconds.

12. The method according to claim 1, wherein a jute mesh is inserted between the first and second polyurethane foam sheets, followed by integrally molding the same.

13. The method according to claim 1, wherein the insulation is partially attached to aluminum & glass cloth (ALGC).

14. An insulation for automobiles, manufactured by the method according to claim 1.

15. The insulation according to claim 14, wherein the insulation is mounted on a dash panel and a hood.
